(19) United States
(12) Patent Application Publication
(10) Pub. No.: US 2013/0218786 A1
(43) Pub. Date: Aug. 22, 2013

(54) Instant Patent Filing Subsystem

(71) Applicant: Wei-Yeh Lee, New York, NY (US)

(72) Inventor: Wei-Yeh Lee, New York, NY (US)

(21) Appl. No.: 13/769,628

(22) Filed: Feb. 18, 2013

Related U.S. Application Data
(60) Provisional application No. 61/599,593, filed on Feb. 16, 2012.

(51) Int. Cl. G06Q 10/06

(52) U.S. Cl. CPC G06Q 10/06; G06Q 50/184
USPC 705/310

(57) ABSTRACT

Systems, methods and computer program products for patent management functions are disclosed. In an aspect of the disclosure, an instant patent filing subsystem provides the management of patent seeds for use in a patent application(s) and/or provisional application(s). In another aspect of the disclosure, an instant patent filing subsystem may be used with (and/or may be included in) a crowdsourcing system. In yet another aspect of the disclosure, an instant patent filing subsystem enables a user to create a patent application(s), provisional application(s), and/or another type of patent-related document by the selection of at least some of the patent seeds and/or the selection of at least one of the collections of patent seeds.

### CROSS-REFERENCE TO RELATED APPLICATION

This application claims the benefit of U.S. Provisional Patent Application 61/599,593 (Atty. Docket No. 2194.03), filed Feb. 16, 2012, and entitled “Instant Patent Filing Subsystem,” the entire contents of which are incorporated herein by reference.

### BACKGROUND OF THE INVENTION

1. Field of the Invention

The present invention generally relates to patent management functions, and more particularly to systems, methods and computer program products for an instant patent filing subsystem.

2. Related Art

Systems that use crowdsourcing typically use open calls in order to request solutions (or answers) to tasks (i.e., contests). The crowdsourcer will send the open call that will be directed to one or more communities (i.e., “crowds”). The open calls are typically made through, for example, web-based technologies such as, for example, web services. The crowdsourcing systems typically provide, in the open calls, the information describing the tasks and any other condition or constraint such as, for example, deadlines, non-disclosure agreements, rewards and/or other parameters. These tasks are typically traditionally performed by employees, contractors, consultants and/or the like. A task can be, for example, product design questions, business plan questions, advertising or marketing questions, or any other suitable question. Therefore, a crowdsourcing system allows the crowdsourcer to be a provider of contests, competitions, or tasks for communities, and the communities can then engage in competition among the community's individual members for the winning solution or valuable answer for the contest, competition, or task.

Crowdsourcing has become popular with businesses, organizations, schools, universities, authors, journalists and other entities as a method to leverage the ability of many individuals to collaborate as a community through wide-area networks such as, for example, the Internet and web-based technologies. In crowdsourcing, the crowdsourcer will own the best solution provided by an individual in a community (or provided by a community) to a task, and the winning individuals in the crowd are sometimes rewarded as permitted by the crowdsourcer. A winning individual (or individuals) can be rewarded by, for example, monetary compensation, prizes, recognition and/or other forms of compensation as set by the crowdsourcer.

Crowdsourcing systems are currently being used by some communities in order to exchange or share patent related publications. For example, Article One Partners, LLC (http://www.articleonepartners.com/) is an online prior art search crowdsourced community where a patent (that the requestor seeks to invalidate) is posted online as a request for relevant prior art research submissions, and rewards are paid to researchers based on the quality of the submissions. As another example, the crowdsourced platform CrowdIPR (http://www.crowdipr.com/) connects technology experts with companies that need patent and technology search. Although crowdsourcing systems are described herein for background information, an aspect of the disclosure to be discussed below does not necessarily require any crowdsourcing system, does not necessarily use any crowdsourcing method, and/or is not necessarily included in a crowdsourcing system or crowdsourcing platform.

Under the crowdsourcing methodology, each crowd needs a very specific and simple task to perform. In contrast, experts (or trained individuals) are required to manage the complexities of a patent or patent application. Any material that can be included in a patent application or provisional application is defined herein as a “patent seed” or “patent seeds”. By way of example and not by way of limitation, a patent seed can be a text material (e.g., one or more words, a definition, a sentence, a paragraph, a formula, an html address, another type of text material or content, and/or a combination of at least two of these text materials or contents), a drawing material (e.g., a block diagram, a sketch, a flow chart, a web shot, a photograph or picture, a state diagram, another type of drawing material or drawing content, and/or a combination of at least two of these drawing materials or contents), appendix materials, a listing of data or listing of content, a published document or published content, a patent-related content or at least a portion of a patent-related content, a patent application related content or at least a portion of a patent-related content, another type of content or another type of material, any content that can be included in a patent application and/or provisional application, and/or a combination of at least two of the aforementioned materials and/or aforementioned contents that can be a patent seed.

Various types of patent docketing and patent authoring tools are known to those skilled in the relevant art(s). However, none of these tools are designed to handle the large (or massive) volumes of patent seeds that can be obtained by an expert. Additionally, current patent docketing/authoring tools and current crowdsourced systems are not designed to gather, present, and manage any patent seed(s).

Therefore, the current technology does not provide any crowdsourced systems that produce patent applications and/or provisional applications. Additionally, the current technology does not provide any system and/or method to permit and/or enable a crowd(s) (i.e., community or communities) to produce (and/or to present) a large or massive number(s) of patent seeds, patent seed packages (i.e., one or more groups or bundles of patent seeds), potential patent seeds, and/or potential patent seed packages. Additionally, the current technology does not provide any system and/or method to permit and/or enable an expert(s) to easily manage these patent seeds, patent seed packages, potential patent seeds, and/or potential patent seed packages, so that an expert (or other individual) can form a patent application(s) and/or provisional application(s), and more importantly, so that the expert can file the patent application(s) and/or provisional application(s).

Additionally, the current technology does not provide any system and/or method to permit and/or enable an expert to rapidly file (in a patent office) one or more patent applications and/or provisional applications by using the patent seeds that are produced and/or presented by a crowd to a crowdsourced system(s). Additionally, the current technology does not provide any system or method to optimize the skill set(s) of an expert (or other individual) in the process of preparing and/or filing a patent application(s) and/or provisional application(s).

Given the foregoing, systems, methods and computer program products for an instant patent filing subsystem are needed.

### BRIEF DESCRIPTION OF THE INVENTION

This summary is provided to introduce a selection of concepts. These concepts are further described below in the Detailed Description. This summary is not intended to identify key features or essential features of the subject matter to be claimed, nor is this summary intended as an aid in determining the scope of the subject matter to be claimed.

The present disclosure meets the above-identified needs by providing systems, methods and computer program products for patent management functions.

In an aspect of the disclosure, an instant patent filing subsystem provides the management of patent seeds for use in a patent application(s) and/or provisional application(s).

In another aspect of the disclosure, an instant patent filing subsystem may be used with (and/or may be included in) a crowdsourcing system.

In yet another aspect of the disclosure, an instant patent filing subsystem enables a user to create a patent application(s), provisional application(s), and/or another type of patent-related document by the selection of at least one or more of the patent seeds and/or the selection of at least one of the collections of patent seeds.

In another aspect of the disclosure, a system or a method implemented as a plugin, software enhancement, or stand-alone program can take the generated patent, provisional patent, or other patent related document and its related meta-data and automatically translate the documents so it can be loaded into a third-party patent management system.

In another aspect of the disclosure, a system or a method implemented as a plugin, software enhancement, or stand-alone program can take a selection of patent seeds and its related meta-data and generate a format specific for a third-party patent management system.

Further features and advantages of the present disclosure, as well as the structure and operation of various aspects of the present disclosure, are described in detail below with reference to the accompanying drawings.

### BRIEF DESCRIPTION OF THE DRAWINGS

The features and advantages of the present disclosure will become more apparent from the detailed description set forth below when taken in conjunction with the drawings in which like reference numbers indicate identical or functionally similar elements. Additionally, the left-most digit of a reference number identifies the drawing in which the reference number first appears.

FIG. 1 is a block diagram of an exemplary system and method for an instant patent filing subsystem according to an aspect of the present disclosure.

FIG. 2 is a block diagram that shows additional details of an instant patent filing subsystem according to an aspect of the present disclosure.

FIG. 3 is a flow diagram of an exemplary method for facilitating an instant patent filing subsystem, according to an aspect of the present disclosure.

FIG. 4 is a block diagram of an exemplary computer system useful for implementing an aspect of the present disclosure.

### DETAILED DESCRIPTION

The present disclosure is directed to systems, methods and computer program products for patent management functions.

In an aspect of the disclosure, an instant patent filing subsystem (“IPFS”) provides the management of patent seeds for use in a patent application(s) and/or provisional patent application(s).

In another aspect of the disclosure, an instant patent filing subsystem may be used with (and/or may be included in) a crowdsourcing system.

In yet another aspect of the disclosure, an instant patent filing subsystem enables a user to create a patent application(s), provisional application(s), and/or another type of patent-related document by the selection of at least some of the patent seeds and/or the selection of at least one of the collections of patent seeds.

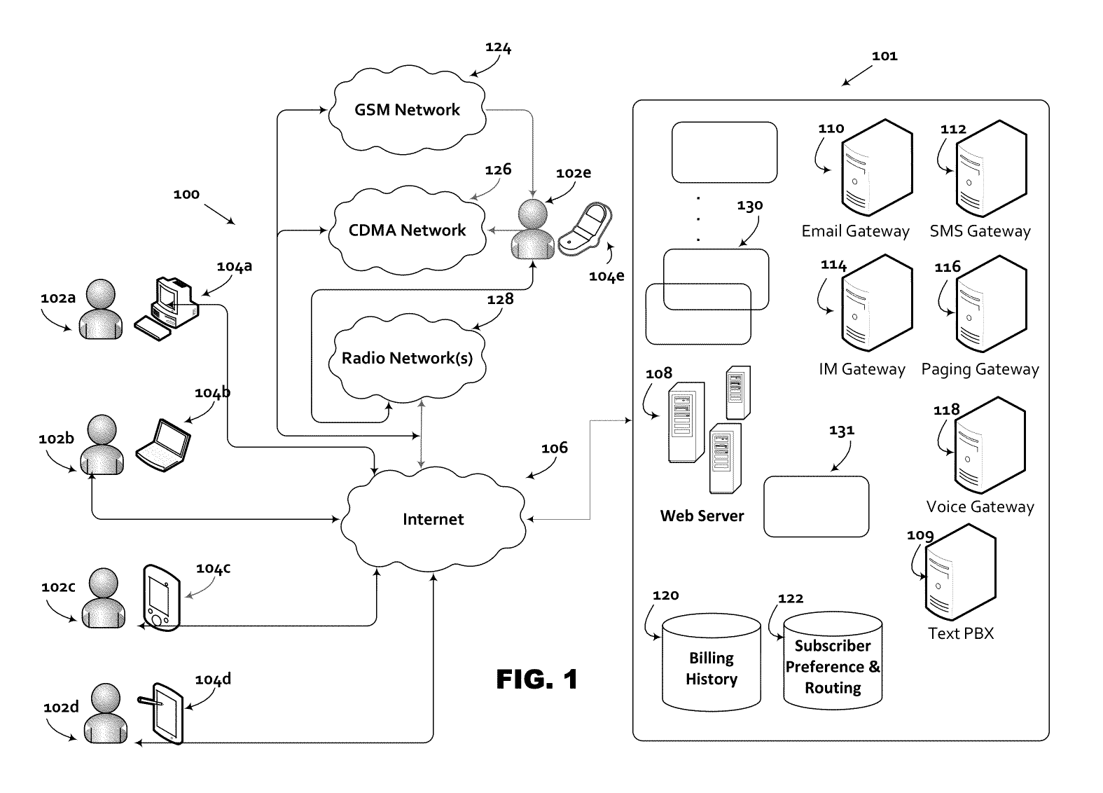

Referring to FIG. 1, a block diagram illustrating an exemplary communication system 100, according to an aspect of the present disclosure, is shown. System 100 includes a plurality of individuals 102 (shown as users 102a-e in FIG. 1) accessing, via a computing device 104 (shown as respective computing devices 104a-e in FIG. 1), a communications network 106, such as, for example, the global, public Internet. Individuals 102 can use computing devices 104 to form a community (or community platform) that belongs in a crowdsourcing system. Computing devices 104 communicate via network 106 to a communication infrastructure 101 that allows the methods or operations discussed below. The hardware and software components in infrastructure 101 are typically all communicatively coupled together.

In one aspect of the disclosure, individuals 102 (when using their respective devices 104) may form a community if a crowdsourcing function is included in communications system 100. In another aspect of the disclosure, a crowdsourcing function is not required or is omitted in communications system 100.

In various aspects, computing device 104 may be configured as a desktop computer 104a, a laptop computer 104b, a personal digital assistant (PDA) 104c, a tablet or mobile computer 104d, any commercially-available intelligent communications device, or the like. Computing devices 104 can be other types of devices that are not shown in FIG. 1 such as, for example, a notebook computer, a server computer, a mobile telephone, a television with Internet browsing capability or other suitable types of computing devices.

As shown in FIG. 1, in an aspect of the present disclosure, infrastructure 101 may be connected to one or more telecommunications networks such as a GSM network 124, a CDMA network 126, a radio network 128 or the like. Such networks 124-128 would allow communication between infrastructure 101 and one or more devices 104e which can be, for example, a mobile telephone that can communicate via the Internet or other wide-area networks.

As will also be appreciated by those skilled in the relevant art(s), in an aspect, various (login, admin, account, information, resource, logout, payment, registration, communications and/or the like) screens would be generated by a server 108 (in infrastructure 101) in response to input from users 102 over network 106. That is, in such an aspect, server 108 is a typical Web server running a server application at a Web site which sends out Web pages in response to Hypertext Transfer Protocol (HTTP) or Hypertext Transfer Protocol Secured (HTTPS) requests from remote browsers in various devices 104 being used by various users 102. Thus, server 108 is able to provide a graphical user interface (GUI) to users 102 of system 100 in the form of Web pages. These Web pages sent to the user's PC, laptop, mobile device, PDA, mobile phone, or the like device 104, and would result in the GUI being displayed.

Various data such as, for example, login and/or account information of participants in a community, can be stored in a database 120 that is accessible by web server 108. In another aspect, the various data can be stored in a memory included in (or coupled to) web server 108.

In another aspect, infrastructure 101 may also include a text PBX server 109, an email gateway server 110, an SMS gateway server 112, an instant message (IM) gateway server 114, a paging gateway server 116 and/or a voice gateway server 118 for allowing other forms of communication to be supported by systems that function within infrastructure 101.

In an aspect of the disclosure, web server 108 is arranged to store, support, operate and/or execute one or more instant patent filing subsystem(s) 130 to be discussed below. In an aspect, each instant patent filing subsystem (IPFS) 130 permits the functions and operations to be discussed in detail below.

In an aspect of the disclosure, web server 108 may be arranged to store, support, operate and/or execute at least one crowdsourcing system 131 with crowdsourcing functions that have been described above and/or that are known to those skilled in the relevant art(s). In an aspect of the disclosure with a crowdsourcing function, the crowdsourcer may be different for each IPFS 130, or a crowdsourcer can use a plurality of instant patent filing subsystems (IPFSs) 130, or a combination of both. In an aspect of the disclosure with a crowdsourcing function, the crowdsourcer may be different for each crowdsourcing system 131, or a crowdsourcer can use multiple crowdsourcing systems 131, or a combination of both.

As will also be appreciated by those skilled in the relevant art(s) after reading the description herein, alternate aspects of the present disclosure may include providing the tool for facilitating the instant patent filing subsystem (e.g., installed on one PC) or as an enterprise system wherein all the components of infrastructure 101 are connected and communicate via an inter-corporate wide area network (WAN) or local area network (LAN), rather than as a Web service (i.e., application service provider (ASP) model) as shown in FIG. 1.

As will also be appreciated by those skilled in the relevant art(s) after reading the description herein, one or more instant patent filing subsystems 130 can be included in other communication systems that is different from or that vary in one or more features from communication system 100.

As will be discussed below, in an aspect of the disclosure, instant patent filing subsystem 130 provides the management of patent seeds for use in a patent application(s) and/or provisional application(s) and/or provides other patent management functions. A provisional application document can be quickly converted into a patent application document that can be filed in a patent office by adding at least one claim and by adding an abstract (as needed) in the provisional application document. In the discussion herein, for purposes of brevity, the terms “application”, “patent application”, and/or “patent-related document” can be a utility patent application, a design patent application, a provisional application, a PCT application, a foreign patent application, and/or another type of patent-related application.

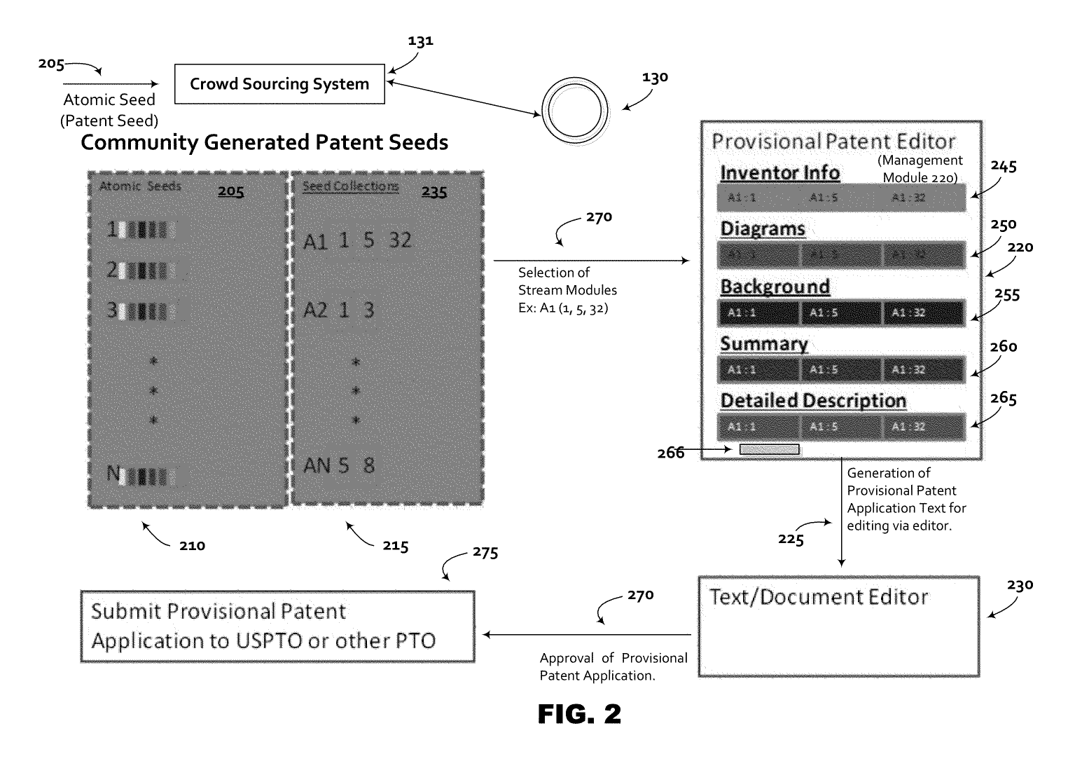

FIG. 2 is a block diagram that shows additional details of an IPFS 130 according to an aspect of the present disclosure. The functions or operations that are performed by IPFS 130 (and the below-described modules in IPFS 130) can be programmed by, for example, the use of a suitable software programming language as known to those skilled in the relevant art(s). Useful machines for performing operations according to an aspect of the present disclosure include, for example, a general purpose digital computer (system 100) or another type of similar device.

In an aspect of the disclosure, IPFS 130 manages a plurality of patent seeds 205 (i.e., atomic seeds 205 or seed collections 235) that are provided by one or more individuals 102 into a crowdsourcing system 131. By way of example and not by way of limitation, a patent seed 205 can be a text material (e.g., one or more words, a definition, a sentence, a paragraph, a formula, an html web address, another type of text material or content, and/or a combination of at least two of these text materials or contents), a drawing material (e.g., a block diagram, a sketch, a flow chart, a web shot, a photograph or picture, a state diagram, another type of drawing material or drawing content, and/or a combination of at least two of these drawing materials or contents), appendix materials, a listing of data or listing of content, a published document or published content, a patent-related content or at least a portion of a patent-related content, a patent application related content or at least a portion of a patent application related content (or provisional application related) content, another type of content or another type of material, any content that can be included in a patent application and/or provisional application, and/or a combination of at least two of the aforementioned materials and/or aforementioned contents that can be a patent seed.

Crowdsourcing system 131 may include components of a standard crowdsourcing system as known to those skilled in the relevant art(s) and can perform standard crowdsourcing functions. In another aspect of the disclosure, crowdsourcing system 131 may include components in a crowdsourcing system disclosed in U.S. Provisional Application Ser. No. 61/513,438, entitled “Aggregate Crowdsourcing Platforms,” filed on Jul. 29, 2011, having common inventorship and which is hereby incorporated by reference in its entirety. However, any suitable standard crowdsourcing system may instead be used to receive patent seeds 205 from individuals 102 belonging to one or more crowdsourced communities.

IPFS 130 includes various modules, systems, or subsystems as shown in some of the block components in FIG. 2. It is understood that the exemplary modules, systems, or subsystems in FIG. 2 to be discussed below can be integrated together in functionalities into one or more modules or combinations of modules. However, for purposes of clarity of discussion of aspects of the disclosure, particular modules, systems, and subsystems or particular systems or subsystems are shown in FIG. 2 as separate block components. Therefore, the exemplary block components in FIG. 2 can be varied in functionalities and can be integrated together into one or more block components.

It is also understood that IPFS 130 can be separate modules that can be configured differently. For example, some of the modules in IPFS 130 can be located on the client-side (e.g., in client devices 104), while other modules in IPFS 130 can be located on the server-side (e.g., in server 108). Other configurations of the locations of IPFS 130 are also possible.

In an aspect of the disclosure, IPFS 130 includes at least one of the following components that will be discussed in detail below: patent seed (i.e., atomic seed or seed collection) management module 210; patent seed collections management module 215; and patent-related content management module 220.

In an aspect of the disclosure, patent-related content management module 220 generates a patent-related content output 225 that can be edited by a content editor 230 (i.e., a text and/or document editor 230) as will be discussed further below. Patent-related content management module 220 may form and/or edit a content (and/or document) that can be included in a provisional application and/or included in a patent application, as will be discussed further below. A provisional application may be, for example, a provisional application that can be filed in a patent office such as, e.g., the United States Patent and Trademark Office (USPTO). A patent application may be, for example, a patent application that can be filed in the USPTO, a national patent application that can be filed in another country (e.g., a patent application that can be filed in a foreign country such as, for example, Canada, Great Britain, or Japan), a regional patent application that can be filed in a patent office (e.g., a European Regional patent application for filing in the European Patent Office), an international application (e.g., a Patent Cooperation Treaty application), and/or another type of patent-related application.

Crowdsourcing system 131 permits crowds 102 to produce and/or input a potentially large number (or massive number) of patent seeds 102. Although FIG. 2 shows only one crowdsourcing system 131, in an aspect of the disclosure, IPFS 130 is configured to receive patent seeds 205 from one or more crowdsourcing systems 131, where crowds 102 will provide patent seeds 205 to crowdsourcing systems 131. IPFS 130 can manage patent seeds 205 and/or patent seed collections 235. A patent seed collection 235 includes a collection (i.e., a bundle or group) of a plurality of patent seeds 205. Therefore, IPFS 130 permits a user (e.g., an expert or any member of a team) to manage patent seeds 205 and/or patent seed collections 235, and IPFS 130 then permits the user to form a provisional application (and/or to form a patent application) by selecting at least a subset of patent seeds 205 and/or at least one or more patent seed collections 235. In contrast, the current technology does not provide any crowdsourced systems that produce patent applications and/or provisional applications.

In an aspect of the disclosure, patent seed management module 210 is configured to gather and receive patent seeds 205 that are received by crowdsourcing system 131 from one or more crowds 102. Patent seed management module 210 is configured to store a plurality of patent seeds 205 into a storage area such as, for example, database 120 or another storage area that can be accessed by IPFS 130. In the example shown in FIG. 2, management module 210 has managed and stored a plurality of patent seeds 1, 2, 3, . . . and N into a storage area, where N can be any suitable integer value. The integer value of N is typically only limited by the available memory space that can store a plurality of patent seeds 205. By way of example and not by way of limitation, patent seeds 1, 2, and 3 can be any text content, a drawing, and listing, respectively. However, as similarly discussed above, patent seeds 1, 2, and 3 can be other types of content.

Seed collections management module 235 is configured to group (i.e., bundle or collect) a plurality of patent seeds 205. In the example of FIG. 2, seed collection A1 is a bundle that includes patent seeds 1, 5, and 32. The number of patent seeds in a seed collection may vary in a suitable number. Seed collection A2 is a bundle that includes patent seeds 1 and 3. Seed collection AN is a bundle that includes 5 and 8. As mentioned above, N may be any suitable integer number.

Any particular patent seed 205 may be bundled in only one particular seed collection or may be bundled in more than one particular seed collection. For example, patent seed 1 is included in seed collections A1 and A2, while patent seed 5 is included in seed collections A1 and AN.

Patent seeds 205 may vary in content type, as previously mentioned above. By way of example and not by way of limitation, any of patent seeds 1, 3, 5, 8, and 32 (or any other patent seed 205) may be of any one of various content type such as a drawing material (e.g., PDF format drawing, Microsoft® Visio® drawing, photograph image, web page image, or other types of drawing material, a text material (e.g., a PDF document, a Microsoft® Word document, a WordPerfect® document, a web page text, a code, a text-format document, or other types of text material), or another suitable content type that.

IPFS 130 is configured transmit any of seed collections A1, A2, . . . and AN, as selected by a user of IPFS 130. For example, when the user selects seed collection A1 to be initially included in a patent-related document 270 (e.g., a provisional application 270 or a patent application 270), IPFS 130 will transmit (or stream) seed collection A1 as a stream module A1 to patent-related content management module 220. A user can select other seed collections (e.g., any of seed collections A2 through AN) to transmit from module 215 to content management module 220 and to be initially included in a patent-related document 270.

A user of IPFS 130 may include, for example, an expert or any individual in a team that may include, for example, the technical staff of the client (or entity), the legal staff of the client (or entity), other technical staff (e.g., internal technical staff), other legal staff (e.g., internal legal staff), outsourced technical staff, outsourced legal staff, lawyers, patent agents, executives or managers of the client (or entity), original inventors, subject matter experts, consultants, engineers, computer scientists, programmers, other technical professionals, and/or another staff, entity, and/or individual.

Content management module 220 is configured to populate any of seed collections A1, A2, . . . and AN into patent-related document sections 245, 250, 255, 260, and 265 as selected by the user. The number of sections that can be populated by module 220 may vary. As one example, module 220 can populate any one of sections 245, 250, 255, 260, and 265 with seed collection A1, can populate some of sections 245, 250, 255, 260, and 265 with seed collection A1, or as shown in FIG. 2, can populate all of sections 245, 250, 255, 260, and 265 with seed collection A1, as selected by the user. Module 220 can also populate any one of, some of, or all of sections 245, 250, 255, 260, and 265 with any one of seed collections A2 through AN, as selected by the user. By way of example and not by way of limitation, sections 250, 255, 260, and 265 correspond to the diagrams section, background section, summary section, and detailed description section, respectively, that may be included in a provisional application. However, it is understood that in a United States provisional application, sections 250, 255, 260, and 265 are not mandatory requirements.

As noted in U.S. patent law, an application for patent requires a specification that shall contain a written description of the disclosure, and of the manner and process of making and using it, in such full, clear, concise, and exact terms as to enable any person skilled in the art to which it pertains, or with which it is most nearly connected, to make and use the same, and shall set forth the best mode contemplated by the inventor of carrying out his disclosure. Diagrams section 250 contains drawings associated with the disclosure. These contents may be input management module 220.

In an aspect of the disclosure, content management module 220 may also populate a cover sheet section 266 (and/or a user may populate data into section 266), as an optional feature. A cover sheet section 266 may be, for example, a cover sheet of a provisional application and/or a transmittal letter for a patent application. A cover sheet may include, for example, at least some of the following data: text indicating the application is a provisional application or application for a utility or design patent; the name(s) of all inventor(s); the residence(s) of all inventor(s); title of disclosure; name and registration number of attorney or agent (if inventor is not signing the application); docket (or reference) number; correspondence address; and any U.S. Government agency that has a property interest in the application (if applicable).

Content management module 220 is configured to allow the user to add, remove (delete), and reorder patent seeds 205 (and/or collections 235 of patent seeds) in any of sections 245, 250, 255, 260, and 266. The user can also input additional data or content into sections 245, 250, 255, 260, and 266. Therefore, content management module 220 allows the user to set the content in an application 270 (e.g., provisional application or patent application) by populating, editing, deleting, reordering, and/or adding to the content in any of sections 245, 250, 255, 260, and 266.

After the user of IPFS 130 has permitted content management module 220 to populate sections 245, 250, 255, 260, and/or 265 with any of seed collections A1, A2, . . . and AN, based on the selection of the user, the user (e.g., expert or an individual in a team) may then actuate a selector (e.g., press a button) in a user interface (e.g., presented in display interface 402) so that content management module 220 will generate an initial patent-related document output 225 that may be received by an editor module 230.

Editor module 230 is configured to convert each patent-related document output 225 into, for example, a flattened editable text format or other suitable viewable and editable format. A flattened editable format is, for example, content that is presented on successive pages such as content in a standard Word document with multiple pages. Editor module 230 may be any suitable text editor and/or document editor that is commercially available from various vendors and performs any standard content editing functions such as adding, deleting, reordering, and/or other editing of content such as, for example, text and/or drawings.

After a user (e.g., an expert or individual in a team) has edited patent-related document 270 by use of editor module 230 and after approval of document 270 (if approval of an individual in the team is required in the process of preparing document 270), the user can file (submit) patent-related document 270 (e.g., provisional application or patent application) to the USPTO or other regional, jurisdictional or national patent office, as represented by reference block 275. This reference block 275 may represent a mechanism for filing a patent-related document or application such as, for example, an electronic file system that allows a user to electronically file a patent-related document 270 (e.g., provisional application or patent application) in a patent office (e.g., the Electronic Filing System (EFS) in the USPTO), may represent the process of printing of document 270 and submitting of document 270 in a postal office, and/or may represent the process of sending patent-related document 270 to a foreign patent attorney for filing in foreign patent office.

In an aspect of the disclosure, IPFS 130 can be a stand-alone application tool that can be executed by a processor in order to permit the functionalities that are described herein and/or to permit an individual and/or a team to rapidly manage a large number of patent seeds. In another aspect of the disclosure, IPFS 130 is one subsystem of a larger crowd-sourced system, such as, for example, a larger crowd-sourced cluster patent management system that is an online tool that enables an individual and/or a team to rapidly manage a large number of patent seeds generated by a community. The user(s) of IPFS 130 will then be empowered to group, collaborate, edit, and/or file one or more provisional applications (or one or more patent applications) by using any subset of patent seeds 205 generated by the community (or communities) providing input into crowdsourcing system 131. As noted above, a user may be a community member, an in-house expert, an employee of an entity using IPFS 130, or an outsourced individual (e.g., outsourced attorney, outsourced patent agent, outsourced consultant, and/or other outsourced persons).

Therefore, in an aspect of the disclosure, IPFS 130 permits any expert of any individual in a team to easily and/or to conveniently use and to manage patent seeds 205 (and/or bundles 235 or collections 235 of patent seeds 205). As mentioned above, patent seeds 205 may be provided and/or generated by a community 102 (or communities 102). IPFS 130 permits any expert or individual in a team to quickly and/or conveniently order and/or to group patent seeds 205 into one or more patent-related documents 270 (e.g., a patent application(s), provisional application(s), PCT application(s), and/or other types of patent-related documents), and make any desired and/or required edits, and generate patent-related document(s) 270 (e.g., a patent application(s), provisional application(s), PCT application(s), and/or other types of patent-related documents). Any expert or individual a team may then file (i.e., submit) a generated patent-related document(s) 270 (e.g., a patent application(s), provisional application(s), PCT application(s), and/or other types of patent-related documents) to a patent office (e.g., USPTO or other patent office).

Therefore, IPFS 130 permits the creation of a patent application, provisional application, and/or patent claims based on patent seeds 205 provided by a community 102 (or communities 102), where patent seeds 205 may be provided by community 102 (or communities 102) to crowdsourcing system 131 and where patent seeds 205 may be related to a specific patent idea and/or specific technical idea presented by the crowdsourcer and/or user of IPFS 130.

At least one advantage provided by IPFS 130 is by allowing an expert or other user to easily manage patent seeds 205 generated by crowds 102 and to use at least some of these patent seeds 205 and/or at least a collection of these patent seeds 205 for producing a provisional application and/or for producing a patent application. Another advantage provided by IPFS 130 is to permit experts, law firms, corporate legal and/or patent departments, consulting firms, and/or other individuals or entities to manage the workflow or process for creating and generating patent applications and/or provisional application. In contrast, current patent docketing tools and current patent authoring tools do not provide the capability to manage and to handle patent seeds 205 that will be produced by crowds 102.

Conventional wisdom and some skeptics believe that only experts and/or other individuals with specialized knowledge, particular work experience, and/or particular educational backgrounds are the only individuals who can produce a constant flow of patentable ideas. However, the use of crowd-sourcing can rapidly create a plethora (or a significant amount) of variations to an original patent application or original provisional application, an issued patent, a published patent application, an original research idea, a published document, other artifacts reflecting a conception of one or more inventions, and/or other documented forms or broadcasted forms that reflect a conception of one or more inventions. Faced with the challenge of handling and making use of the high volumes of documents and/or artifacts that can be potentially generated crowds, an aspect of IPFS 130 permits a rapid review and management of these patent seeds 205 (e.g., documents, artifacts, and/or other types patent seeds 205) and IPFS 130 permits a duplication and modification of these patent seeds 205 and permits additions of content to these patent seeds 205, so that these patent seeds 205 can be used in a patent application or provisional application that a user of IPFS 130 (or other individual) can file in a patent office.

Other possible advantages may be provided by IPFS 130. For example, in an aspect of the disclosure, IPFS 130 may permit an entity (e.g., a company, organization, group, partnership, joint-venture, individual, and/or another type entity) to: (1) raise or increase the volume of patent applications (and/or provisional applications) that are produced through automation; (2) utilize resources that are geographically dispersed (e.g., patent seeds 205 that are located in different geographical regions or patent seeds 205 provided by crowds 102 that are geographically dispersed); (3) utilize resources from external outsourced attorneys and/or patent agents and/or consultants for an expert team formed by an entity using IPFS 130; and/or (4) utilize community members for the expert team. These possible advantages permit a user of IPFS 130 to rapidly prepare and/or rapidly file a patent application(s) (and/or a provisional application(s)) from patent seeds 205 produced and/or provided by crowd(s) 102.

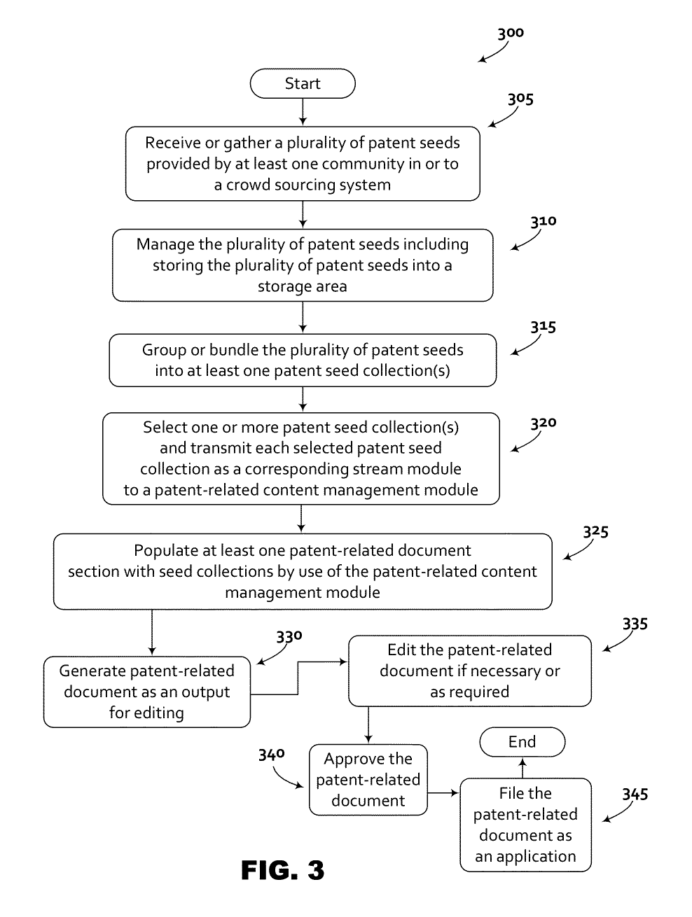

FIG. 3 is a flow diagram of an exemplary method 300 for facilitating an instant patent filing subsystem, according to an aspect of the present disclosure. In block 305, module 210 in IPFS 130 receives (or gathers) a plurality of patent seeds provided by at least one community in or to a crowdsourcing system. In block 310, module 210 in IPFS 130 manages the plurality of patent seeds, and module 210 stores the plurality of patent seeds in a storage area.

In block 315, module 215 in IPFS 130 groups or bundles the plurality of patent seeds into at least one patent seed collection(s). In block 320, module 215 is configured to select one or more patent seed collection(s) and is configured to transmit each selected patent seed collection(s) as a corresponding stream module to a patent-related content management module.

In block 325, content management module 220 populates at least one patent-related document section(s) with at least one seed collection(s). The user can further edit the content in each patent-related document section(s).

In block 330, content management module 220 generates a patent-related document as an output for editing by a user.

In block 335, editor module 230 permits a user to edit the patent-related document if necessary or as required or desired by the user. In block 340, a user (or another individual in a team) can approve the patent-related document after editing by editor module 230.

In block 345, a user (or another individual in the team) can file the patent-related document in the USPTO or other patent office as a provisional application or patent application.

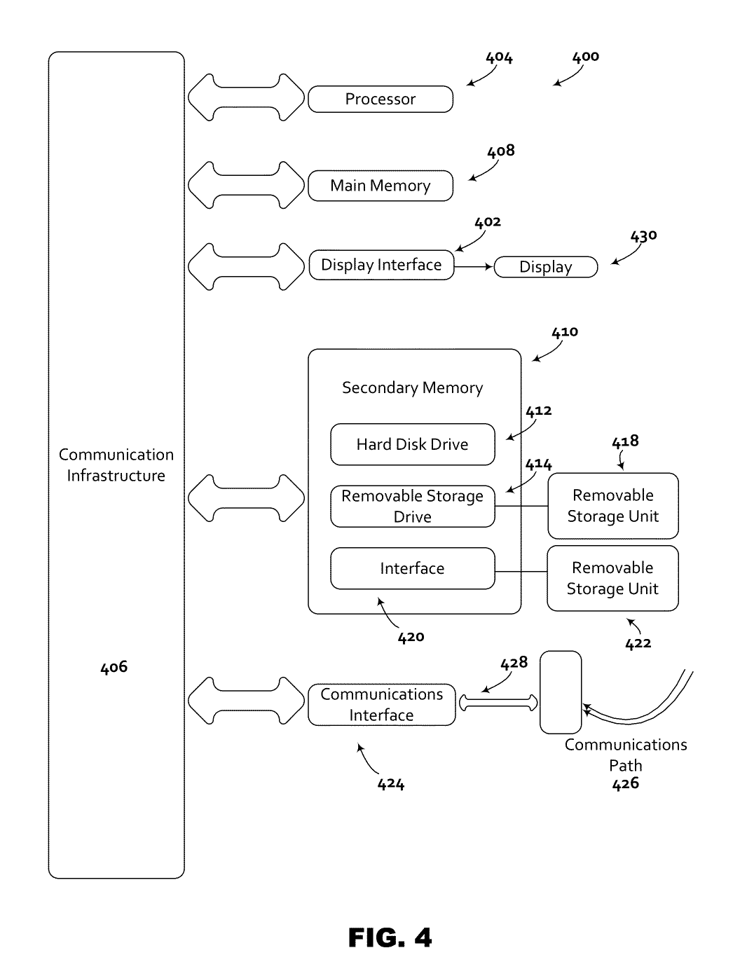

FIG. 4 is a block diagram of an exemplary computer system useful for implementing an aspect of the present disclosure. In one aspect, system 100 may be directed toward one or more computer systems capable of carrying out the functionality (e.g., process 300 or the FIG. 2 functions) described herein. An example of a computer system 400 is shown in FIG. 4. Computer system 400 includes one or more processors, such as processor 404. Processor 404 may be connected to a communication infrastructure 406, such as a communications bus or network, for example. Various software aspects are described in terms of this exemplary computer system. After reading this description, it will become apparent to a person skilled in the relevant art(s) how to implement the disclosure using other computer systems and/or architectures.

Computer system 400 can include a display interface 402 that forwards graphics, text and other data from communication infrastructure 406, or from a frame buffer (not shown), for display via display unit 430. Computer system 400 may also include a main memory 408, preferably a random access memory (RAM), and may further include a secondary memory 410. Secondary memory 410 may include, for example, a hard disk drive 412 and/or a removable storage drive 414, representing a floppy disk drive, a magnetic tape drive, or an optical disk drive, for example. Removable storage drive 414 reads from and/or writes to a removable storage unit 418 in a manner well known in the relevant art. Removable storage unit 418 represents a floppy disk, magnetic tape, or an optical disk, which is read by and written to by removable storage drive 414. As can be appreciated, removable storage unit 418 includes a computer usable storage medium having stored therein computer software and/or data.

In alternative aspects, secondary memory 410 may include other similar devices for allowing computer programs or other instructions to be loaded into computer system 400. Such devices may include, for example, a removable storage unit 422 and an interface 420. Examples of such may include a program cartridge and cartridge interface, such as may be found in video game devices, a removable memory chip, such as an erasable programmable read only memory (EPROM), or programmable read only memory (PROM), and associated socket and other removable storage units 422 and interfaces 420, which allow software and data to be transferred from removable storage unit 422 to computer system 400.

Computer system 400 may also include a communications interface 424. Communications interface 424 allows software and data to be transferred between computer system 400 and external devices. Examples of a communications interface 424 may include a modem, a network interface such as an Ethernet card, a communications port, and a Personal Computer Memory Card International Association (PCMCIA) slot and card. Software and data transferred via communications interface 424 are in the form of non-transitory signals 428 which may be electronic, electromagnetic, optical or other signals capable of being received by communications interface 424. Signals 428 may be provided to communications interface 424 via a communications path or channel 426. Channel 426 may carry signals 428 and may be implemented using wire or cable, fiber optics, a telephone line, a cellular link, a radio frequency (RF) link, and other communications channels.

In this document, the terms “computer program medium” and “computer usable medium” are used to generally refer to media such as removable storage drive 414, a hard disk installed in hard disk drive 412, and signals 428. These computer program products provide software to computer system 400, wherein the present disclosure is directed to such computer program products.

Computer programs (also referred to as computer control logic), may be stored in main memory 408 and/or secondary memory 410. Computer programs may also be received via communications interface 424. Such computer programs, when executed, enable computer system 400 to perform the features of the present disclosure, as discussed herein. In particular, the computer programs, when executed, enable processor 404 to perform the features of the present disclosure. Accordingly, such computer programs represent controllers of computer system 400.

In an aspect where the disclosure is implemented using software, the software may be stored in a computer program product and loaded into computer system 400 using removable storage drive 414, hard drive 412 or communications interface 424. The control logic (software), when executed by processor 404, causes processor 404 to perform the functions of the disclosure as described herein.

In another aspect, the disclosure is implemented primarily in hardware using, for example, hardware components such as application specific integrated circuits (ASICs). Implementation of the hardware state machine so as to perform the functions described herein will be apparent to persons skilled in the relevant art(s).

As will be apparent to one skilled in the relevant art(s) after reading the description herein, the computer architecture shown herein in various drawings may be configured as a desktop, a laptop, a server, a tablet computer, a PDA, a mobile computer, an intelligent communications device or the like. In yet another aspect, the disclosure may be implemented using a combination of both hardware and software.

While various aspects of the present disclosure have been described above, it should be understood that they have been presented by way of example and not limitation. It will be apparent to persons skilled in the relevant art(s) that various changes in form and detail can be made therein without departing from the spirit and scope of the present disclosure. Thus, the present disclosure should not be limited by any of the above described exemplary aspects.

In addition, it should be understood that the figures in the attachments, which highlight the structure, methodology, functionality and advantages of the present disclosure, are presented for example purposes only. The present disclosure is sufficiently flexible and configurable, such that it may be implemented in ways other than that shown in the accompanying figures.

Further, the purpose of the foregoing Abstract is to enable the U.S. Patent and Trademark Office and the public generally and especially the scientists, engineers and practitioners in the relevant art(s) who are not familiar with patent or legal terms or phraseology, to determine quickly from a cursory inspection the nature and essence of this technical disclosure. The Abstract is not intended to be limiting as to the scope of the present disclosure in any way.

What is claimed is:

1. A computer-implemented method for creating patent-related documents using multiple sources of patent-related content, the method comprising:
(a) receiving a plurality of patent seeds generated by a plurality of users in a user community, wherein at least one of the plurality of patent seeds comprises patent-related content;
(b) storing the plurality of patent seeds in a database;
(c) receiving a selection of at least one of the plurality of patent seeds stored in the database; and
(d) populating a patent-related document with the selected patent seeds of step (c).

2. The method of claim 1, wherein the patent-related document is one of: a provisional patent application, a non-provisional utility patent application, a design patent application, a Patent Cooperation Treaty application, a statutory invention registration, and a defensive publication.

3. The method of claim 1, further comprising:
(e) presenting the patent-related document to a user in the user community for editing;
(f) receiving an edit of the patent-related document;
(g) determining if the edit of the patent-related document is approved; and
(h) where determining step (g) is positive, integrating the edit into the patent-related document.

4. The method of claim 1, further comprising:
(i) filing the patent-related document with a patent office.

5. The method of claim 4, wherein the patent office is one of: the United States Patent and Trademark Office, the European Patent Office, the Japan Patent Office, the German Patent Office, and the State Intellectual Property Office of the People's Republic of China.

6. The method of claim 1, wherein the plurality of patent seeds comprises:
a first patent seed; and
a second patent seed;
wherein the first patent seed is created by a first user and the second patent seed is created by a second user.

7. The method of claim 1, further comprising:
(j) grouping patent seeds into at least one patent seed collection;
(k) storing patent seed collection data in the database;
(l) selecting at least one patent seed collection stored in the database; and
(m) populating a patent-related document with the selected patent seed collection of step (l).

8. A computer system for facilitating creation of patent-related documents using multiple sources of patent-related content, comprising:
(a) a seed collections management module configured to receive a plurality of patent seeds generated by a plurality of users in a user community, wherein at least one of the plurality of patent seeds comprising patent-related content;
(b) a database configured to store the plurality of patent seeds;
(c) a patent seed management module configured to receive a selection of at least one of the plurality of patent seeds stored in the database; and
(d) a content management module configured to populate a patent-related document with the patent seeds selected via the patent seed management module.

9. The computer system of claim 8, wherein the patent-related document is one of:
a provisional patent application, a non-provisional utility patent application, a design patent application, a Patent Cooperation Treaty application, a statutory invention registration, and a defensive publication.

10. The computer system of claim 8, further comprising:
(e) an editor module configured to present the patent-related document to a user in the user community for editing and to receive an edit of the patent-related document;
wherein the content management module is further configured to determine if the received edit of the patent-related document is approved and, where the received edit is approved, integrate the received edit into the patent-related document.

11. The computer system of claim 8, further comprising:
(f) a filing module configured to file the patent-related document with a patent office.

12. The computer system of claim 8, wherein the plurality of patent seeds comprises:
a first patent seed; and
a second patent seed;
wherein the first patent seed is created by a first user and the second patent seed is created by a second user.

13. The computer system of claim 8, further comprising:
(g) a patent seed collection module configured to group patent seeds into a patent seed collection;
wherein the database is further configured to store patent seed collection data;
wherein a patent seed management module is further configured to select at least one patent seed collection stored in the database; and
wherein the content management module is further configured to populate a patent-related document with the patent seed collection selected via the patent seed management module.

14. A computer program product comprising computer usable medium encoded in a computer having control logic stored therein for causing the computer to create patent-related documents using multiple sources of patent-related content, the control logic comprising:
first computer readable program code means for causing the computer to receive a plurality of patent seeds generated by a plurality of users in a user community, wherein at least one of the plurality of patent seeds comprising patent-related content;
second computer readable program code means for causing the computer to store the plurality of patent seeds in a database;
third computer readable program code means for causing the computer to receive a selection at least one of the plurality of patent seeds stored in the database; and
fourth computer readable program code means for causing the computer to populate a patent-related document with the selected patent seeds.

15. The computer program product of claim 14, wherein the patent-related document is one of: a provisional patent application, a non-provisional utility patent application, a design patent application, a Patent Cooperation Treaty application, a statutory invention registration, and a defensive publication.

16. The computer program product of claim 14, further comprising:
fifth computer readable program code means for causing the computer to present the patent-related document to a user in the user community for editing;
sixth computer readable program code means for causing the computer to receive an edit of the patent-related document;
seventh computer readable program code means for causing the computer to determine if the edit of the patent-related document is approved; and
eighth computer readable program code means for causing the computer to, where the edit of the patent-related document is approved, integrate the edit into the patent-related document.

17. The computer program product of claim 14, further comprising:
ninth computer readable program code means for causing the computer to file the patent-related document with a patent office.

18. The computer program product of claim 17, wherein the patent office is one of: the United States Patent and Trademark Office, the European Patent Office, the Japan Patent Office, the German Patent Office, and the State Intellectual Property Office of the People's Republic of China.

19. The computer program product of claim 14, herein the plurality of patent seeds comprises:
a first patent seed; and
a second patent seed;
wherein the first patent seed is created by a first user and the second patent seed is created by a second user.

20. The computer program product of claim 14, further comprising:
tenth computer readable program code means for causing the computer to group patent seeds into at least one patent seed collection;
eleventh computer readable program code means for causing the computer to store patent seed collection data in the database;
twelfth computer readable program code means for causing the computer to select at least one patent seed collection stored in the database; and
thirteenth computer readable program code means for causing the computer to populate a patent-related document with the selected patent seed collection.
